(19) United States
(12) Patent Application Publication
(10) Pub. No.: US 2007/0247577 A1
(43) Pub. Date: Oct. 25, 2007

(54) Liquid crystal display and method for manufacturing the same

(75) Inventors: I-An Yao, Miao-Li (TW); Chueh-Ju Chen, Miao-Li (TW); Shu-Hui Chang, Miao-Li (TW); Chiu-Lien Yang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/788,160

(22) Filed: Apr. 19, 2007

(30) Foreign Application Priority Data
Apr. 19, 2006 (CN) 200610060394.5

(51) Int. Cl. G02F 1/1337

(52) U.S. Cl. 349/124

(57) ABSTRACT

An exemplary liquid crystal display includes two substrates (21, 22) opposite to each other and spaced apart a predetermined distance, each of the substrates having an alignment layer (211, 221); a liquid crystal layer (23) between the two substrates, and having a plurality of liquid crystal molecules; and a plurality of gate lines (241) formed between one alignment layer and one substrate. The two alignment layers have two orthogonal aligning directions, one aligning direction of the two alignment layers being parallel to an extending direction of the gate lines.

### BACKGROUND OF THE INVENTION

1. Field of the Invention

The present invention relates to liquid crystal displays (LCDs), and particularly to an LCD having a good display characteristics and a method for manufacturing the LCD.

2. General Background

In general, an LCD has two main advantages in comparison with cathode ray tubes (CRTs): LCDs are thin and have low power consumption. It has been said that LCDs might one day completely replace CRT display devices, and LCDs have aroused great interest in many industries in recent times.

However, LCDs generally provide a narrower viewing angle compared with CRT display devices. Various means have been devised in endeavoring to widen the viewing angle of LCDs. FIG. 5 is a viewing angle versus luminance plot illustrating the gray characteristics of a typical LCD. The various curves represent driving voltages from 0.4V to 4.0V applied thereon. Gray level performance of an LCD is very important. FIG. 5 shows the typical LCD having an undersirable display characteristic because of the inversion hump present in the area of the viewing angle larger than about 50 degrees. The term “inversion hump” means that the luminance aspect of the curves monotonically decreases as the driving voltage increases. For example, 0.4 and 2.0 volts increase, the luminance of radiation emitted from a pixel decreases accordingly in the viewing angle range larger than about 50 degrees.

FIG. 6 is a contrast ratio curve graph for the typical LCD of FIG. 5. The Circumference line represents a polar angle of the LCD. Four concentric circles sequentially illustrate directions inclined at angles of 20.0 degrees, 40.0 degrees, 60.0 degrees, and 28.0 degrees with respect to the normal of a display of the LCD from the center toward the outside. Curve line 10 illustrates a region where the value of the contrast ratio is 10:1, and curve line 100 illustrates a region where the value of the contrast ratio is 100:1. At the region of polar angle 270 degrees, the viewing angle is less than 80 degrees.

Thus, what is needed is an LCD and a method for manufacturing the LCD that can overcome the above-mentioned disadvantages is desired.

### SUMMARY OF THE INVENTION

An exemplary liquid crystal display includes two substrates opposite to each other and spaced apart a predetermined distance, each of the substrates having an alignment layer; a liquid crystal layer between the two substrates, and having a plurality of liquid crystal molecules; and a plurality of gate lines formed between one alignment layer and one substrate. The two alignment layers have two orthogonal aligning directions, one aligning direction of the two alignment layers being parallel to an extending direction of the gate lines.

An exemplary method for manufacturing an LCD comprises the following steps: providing two substrates; forming two alignment films on the two substrates, respectively; forming a plurality of gate lines of one of the substrate; aligning the two alignment films; adhering the two substrates, making the two alignment films facing to each other, and the aligning directions of the two alignment films orthogonal to each other, and one of the aligning direction of the two alignment films being perpendicular to the extending direction of the gate lines; filling liquid crystal moleculars between an space defined by the adhered two substrates.

Other objects, advantages and novel features of the invention will become more apparent from the following detailed description when taken in conjunction with the accompanying drawings.

### BRIEF DESCRIPTION OF THE DRAWINGS

FIG. 1 is a schematic, cross-sectional view of part of an LCD in accordance with a preferred embodiment of the present invention, which has a second substrate;

FIG. 2 is a schematic top view of the second substrate of FIG. 1;

FIG. 3 is a viewing angle versus luminance plot illustrating the gray level characteristics of the LCD of FIG. 1;

FIG. 4 is a contrast ratio curve graph showing viewing characteristics of the LCD of FIG. 1;

FIG. 5 is a viewing angle versus luminance plot illustrating the gray level characteristics of a conventional LCD;

FIG. 6 is a contrast ratio curve graph showing viewing characteristics of the LCD of FIG. 5;

### DETAILED DESCRIPTION OF THE PREFERRED EMBODIMENT

Hereinafter, preferred embodiments of the present invention will be explained in more detail with reference to the accompanying drawings.

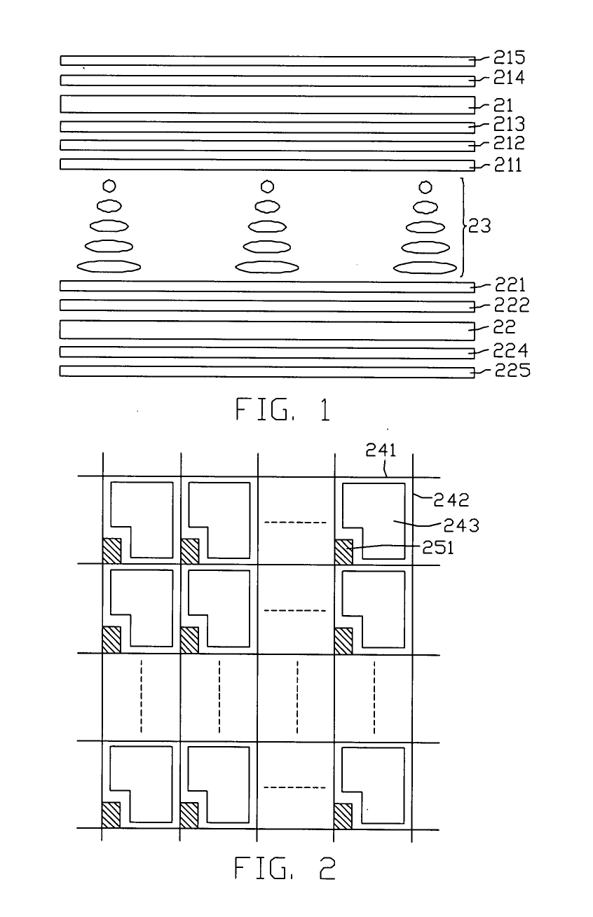

As shown in FIGS. 1 and 2, an LCD according to a preferred embodiment of the present invention includes a first substrate 21, a second substrate 22 disposed parallel to and spaced apart from the first substrate 21, and a liquid crystal layer 23 having liquid crystal molecules (not labeled) sandwiched between the two substrates 22 and 21. The liquid crystal layer 23 is positive or negative liquid crystal material.

A color filter 213, a common electrode 212 and a first alignment film 211 are orderly formed on an inner surface of the first substrate 21, from top to bottom. The first alignment film 211 has a first aligning direction. The LCD 2 further has a first retardation film 214 and a first polarizer 215, which are orderly disposed on an outer surface of the first substrate 21, from bottom to top.

A pixel electrode array 222 and a second alignment film 221 are orderly formed on an inner surface of the first substrate 21, from top to bottom. The second alignment film 221 has a second aligning direction, which is orthogonal to the first aligning direction of the first alignment film 211. A second retardation film 224 and a second polarizer 225 are orderly disposed on an outer surface of the second substrate 22, from top to bottom.

In addition, the pixel electrode array 222 includes a plurality of gate lines 241 that are parallel to each other and that each extend along a first direction, and a plurality of data lines 242 that are parallel to each other and that each extend along a second direction orthogonal to the first direction. The smallest rectangular area formed by any two adjacent gate lines 241 together with any two adjacent data lines 242 defines a pixel region thereat. In each pixel region, a thin film transistor (TFT) 251 is provided in the vicinity of a respective point of intersection of one of the gate lines 241 and one of the data lines 242. In each pixel region, a pixel electrode 243 is connected to the TFT 251. The gate lines 241 extend along the first direction, which is parallel to any one of the first and the second aligning directions of the first and second alignment films 211, 221.

The common electrode 212 and the pixel electrode 243 are made of a transparent conductive material, such as indium-tin-oxide (ITO) or indium-zinc-oxide (IZO).

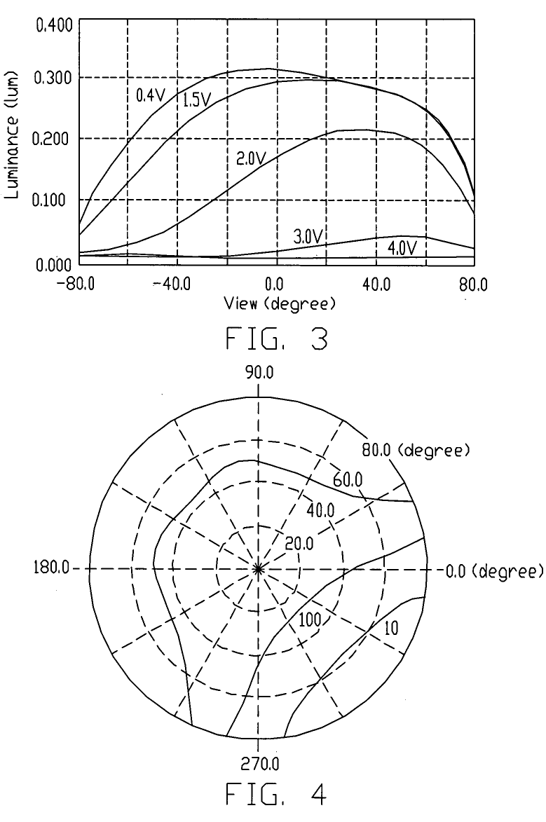

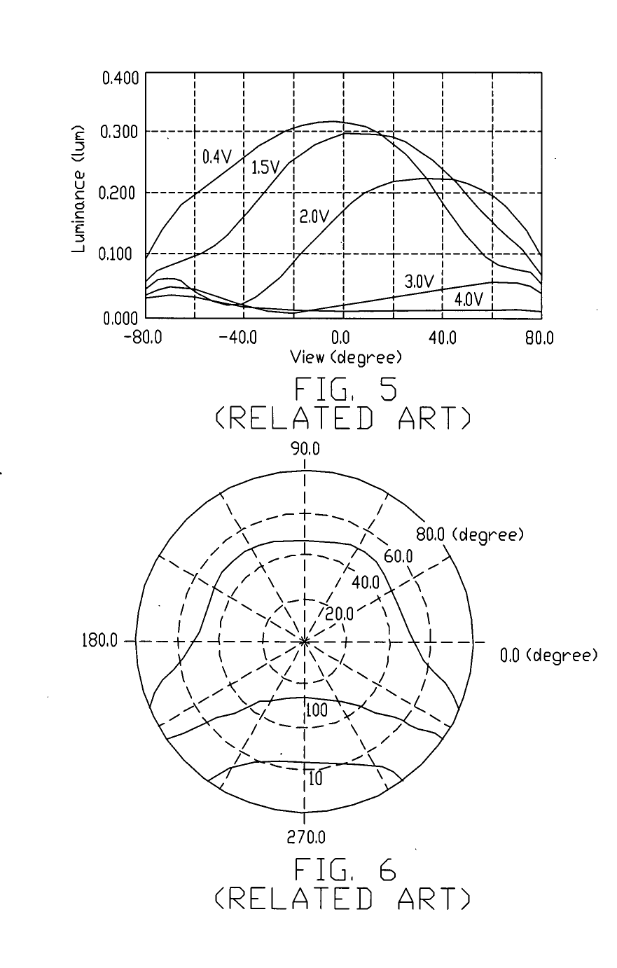

FIG. 3 is a viewing angle versus luminance plot illustrating the gray characteristics of a typical LCD. The various curves represent driving voltages from 0.4V to 4.0V applied thereon. From the drawing, we can see no inversion hump is produced. That is, in the whole viewing angle area, no the phenomena of luminance aspect of the curves monotonically decreasing as the driving voltage increases.

FIG. 4 is a contrast ratio curve graph for the typical LCD of FIG. 3. The Circumference line represents a polar angle of the LCD. Four concentric circles sequentially illustrate directions inclined at angles of 20.0 degrees, 40.0 degrees, 60.0 degrees, and 28.0 degrees with respect to the normal of a display of the LCD from the center toward the outside. Curve line 10 illustrates a region where the value of the contrast is 10:1, and curve line 100 illustrates a region where the value of the contrast is 100:1. At the region of polar angle 270 degrees, the viewing angle is larger than 80 degrees.

The LCD can be manufactured by a following method. The method mainly includes the following steps:

step a: providing the first substrate 21;

step b: forming the color filter 213 and a conductive film on the first substrate 21;

step c: providing the second substrate 22;

step d: forming the plurality of parallel gate lines 241, the plurality of parallel data lines 242 orthogonal to the gate lines 241, and the plurality of TFTs 251 in the vicinity of a respective point of intersection of each of the gate lines 241 and each of the data lines 242;

step e: forming a conductive film on the second substrate 22;

step f: forming the first and the second alignment films 211, 221 respectively on the first and the second substrates 21, 22;

step g: aligning the first and the second alignment films 211, 221;

step h: adhering the first and the second substrates 21, 22, wherein the alignment directions of the first and the second alignment films 211, 221 are orthogonal to each other, and one of the alignment direction of the first and the second alignment films 211, 221 are parallel to the gate lines 241;

step i: filling liquid crystal moleculars into a space defined between the adhered first and the second substrates 21, 22;

step j: providing the first and the second retardation films 214, 224 respectively on the outer surfaces of the first and the second substrates 21, 22; and

step k: providing the first and the second polarizers 215, 225 respectively on the outer surfaces of the first and the second retardation films 214, 224.

In the step g, the first and the second alignment films 211, 221 can be aligned through rubbing method, lithography method, ion beam bombarding method and UV illuminating method.

The LCD utilizes one of the two alignment films 211, 221 having an aligning direction parallel to the gate lines 241 to realize a good viewing angle characteristics as shown in FIGS. 3 and 4.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

We claim:

1. A liquid crystal display comprising:
two substrates opposite to each other and spaced apart a predetermined distance, each of the substrates having an alignment layer;
a liquid crystal layer between the two substrates, and having a plurality of liquid crystal molecules; and
a plurality of gate lines formed between one alignment layer and one substrate;
wherein the two alignment layers have two orthogonal aligning directions, one aligning direction of the two alignment layers being parallel to an extending direction of the gate lines.

2. The liquid crystal display of claim 1, wherein the two substrates is a first substrate and a second substrate.

3. The liquid crystal display of claim 2, wherein the gate lines are formed at an inner surface of the second substrate.

4. The liquid crystal display of claim 3, wherein a common electrode is formed at an inner surface of the first substrate.

5. The liquid crystal display of claim 4, wherein the two alignment layers are a first alignment layer provided at the common electrode, and a second alignment layer provided at the gate lines.

6. The liquid crystal display of claim 5, wherein one of the first and the second alignment layers has an aligning direction parallel to the extending direction of the gate lines.

7. The liquid crystal display of claim 1, further comprising a plurality of data lines that are parallel to each other and that each extend along a direction orthogonal to the gate lines, and a plurality of TFTs provided in the vicinity of a respective point of intersection of one of the gate lines and one of the data lines.

8. A method for manufacturing an LCD comprises the following steps:
providing two substrates;
forming two alignment films on the two substrates, respectively;
forming a plurality of gate lines on one of the substrate;
aligning the two alignment films;
adhering the two substrates, making the two alignment films facing to each other, and the aligning directions of the two alignment films orthogonal to each other, and one of the aligning direction of the two alignment films being perpendicular to the extending direction of the gate lines;
filling liquid crystal moleculars between an space defined by the adhered two substrates.

9. The method of claim 8, wherein the two alignment films can be aligned through rubbing method, lithography method, ion beam bombarding method and UV illuminating method.

10. The method of claim 8, further comprising a step of forming two conductive films on the two substrates, respectively.

11. The method of claim 8, further comprising a step of providing two retardation films respectively on outer surfaces of the two substrates.

12. The method of claim 11, further comprising a step of providing two polarizers respectively on outer surfaces of the two retardation films.
